(19) United States
(12) Patent Application Publication
(10) Pub. No.: US 2008/0136654 A1
(43) Pub. Date: Jun. 12, 2008

(54) METHODS AND DEVICES FOR POWER SOURCE LIFE VALUE CALCULATION AND REPRESENTATION

(75) Inventors: ANDRE TORIELLO, CAMPINAS (BR); ALEX DIAS DE CARVALHO, CAMPINAS (BR); RICHARD A. PACE, CHAMPAIGN, IL (US); PAUL R. POULOSKY, URBANA, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/609,555

(22) Filed: Dec. 12, 2006

(51) Int. Cl. G08B 21/00

(52) U.S. Cl. 340/636.1

(57) ABSTRACT

Disclosed are devices configured to execute multiple functions and methods for calculating a remaining power source life value. A method can include providing information related to the remaining power source life value correlated to operation of at least one of the multiple functions. Downloaded current drain information related to current drain during operation of at least one of multiple functions may be received by the device and/or may be internally detected. A current drain profile stored in memory may be updated based on current drain information. A remaining power source life value and/or a time-to-charge value can then be calculated, based on the updated current drain profile.

### FIELD

Disclosed are devices configured to execute multiple functions and methods for calculating a remaining power source life value, and more particularly, devices and methods that include a current drain profile for calculating a remaining power source life value correlated to operation of multiple functions.

### BACKGROUND

The makers of mobile communication devices, including those of cellular telephones, are increasingly adding functionality to their devices. For example, cellular telephones can include features such as gaming, still and video cameras, video streaming and two-way video calling, email functionality, Internet browsers, media players, AM/FM radios, organizers, and mobile commerce such as banking, payment and ticketing. Cellular telephones are evolving into powerful tools for information management.

As users spend more time executing functions of their mobile communication devices, instead of keeping their devices on stand-by, they can consume substantial power from the power source of the device. Traditionally, a power source indicator may be depicted on the display screen of the device as a battery icon where the remaining power is indicated by threshold indicia. During stand-by, the power source indicator may provide useful information as to whether a user may rely on a power source for a predetermined period of time. However, once the user executes one of the many functions of the device, the power source indicator may be inadequate to indicate available power for that function or other functions.

### BRIEF DESCRIPTION OF THE DRAWINGS

FIG. 1 depicts an electronic device such as a mobile communication device;

FIG. 2 is a flow chart of an embodiment of steps of a method described with reference to certain components of the mobile communication device;

FIG. 3 illustrates an example of historical pattern data that can be stored in memory of the device;

FIG. 4 depicts a statistical model diagram;

FIG. 5 depicts a display screen providing an embodiment of indicia related to the remaining power source life value correlated to operation of at least one of the multiple functions of the device;

FIG. 6 depicts a display screen providing an embodiment of indicia related to the remaining power source life value based on hypothetical percentages or other hypothetical criteria that may be entered by the user; and

FIG. 7 depicts a display screen providing an embodiment of indicia relating to a time-to-charge value.

### DETAILED DESCRIPTION

It would be beneficial if a power source indicator could provide information related to a remaining power source life value for the power source correlated to operation of at least one of the multiple functions of the device. In this way, a user may be apprised of the power supply consequences of running particular functions of his or her mobile communication device. A user may be better able to plan their time, try new use cases, and increase network utilization when better informed about the remaining power source life value and/or time-to-charge value.

Disclosed is a device configured to execute multiple functions and a method for calculating a remaining power source life value correlated to operation of at least one of the multiple functions. Furthermore, the method can include providing information related to the remaining power source life value correlated to operation of at least one of the multiple functions. In one embodiment, downloaded current drain information related to current drain during operation of at least one of multiple functions may be received by the device. A current drain profile stored in memory may be updated based on the downloaded current drain information to generate an updated current drain profile.

In another embodiment, the current drain of the power source may be internally monitored by the device in conjunction with operation of at least one of the multiple functions to generate power consumption data. A current drain profile stored in memory can be updated to generate an updated current drain profile based on the power consumption data. A remaining power source life value can then be calculated for the power source correlated to operation of at least one of the multiple functions, based on the updated current drain profile.

In another embodiment, a device may be configured to execute multiple functions and a method may include calculation of a time-to-charge value based on the remaining power source life value correlated with and during operation of at least one of the multiple functions. The method can include providing information relating to the time-to-charge value correlated with operation of at least one of the multiple functions.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

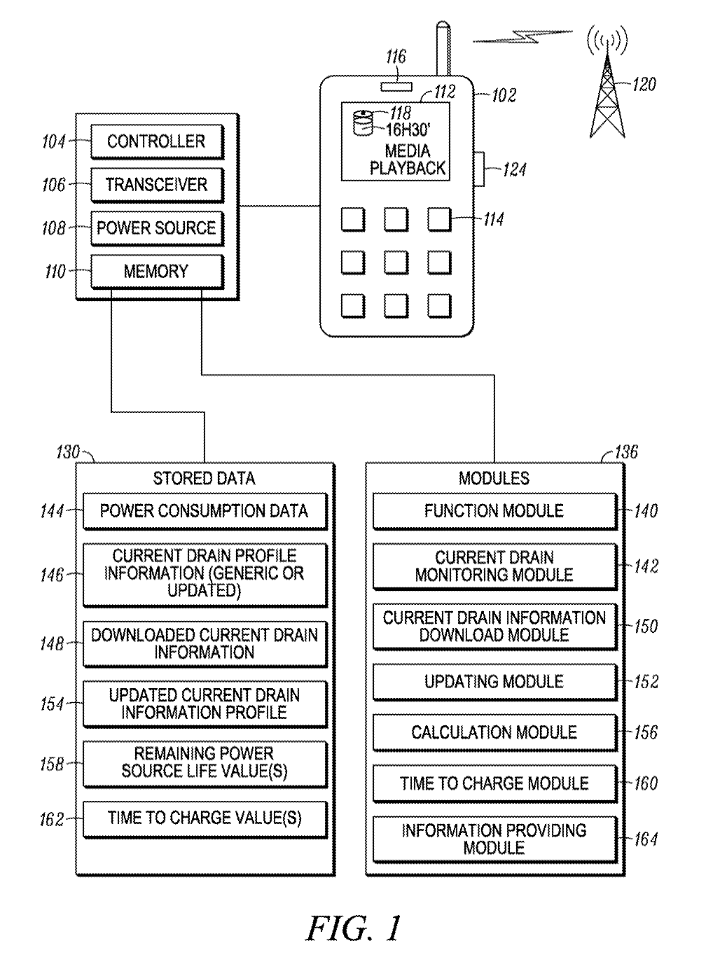

FIG. 1 depicts an electronic device such as a mobile communication device 102.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device 102 can include a controller 104, a transceiver 106, a power source 108 and a memory 110. Moreover, the device can include a display 112 and an input device such as a key pad 114. Indicia may be displayed on the display 112. Information may also be annunciated by a speaker 116 of the device, or may be communicated in any other suitable manner. Depicted on the display 112 of the device 102 is an example of indicia 118 representing a battery with a time indicator that may be used to provide the remaining power source life value correlated to operation of at least one of the multiple functions. Any type of time indicator may provide the time remaining for a function, including stand-by. In this way, a user may be apprised of the power supply consequences of running particular functions of his or her mobile communication device 102.

As mentioned, the device 102 may include a power source 108. The power source 108 may be for example, one or more of a battery cell, fuel cell, supercapacitor, or a combination thereof. During the execution of a function, current may drain from the power source 108. Information, such as a profile, relating to the current drain from the power source 108 may be detected internally and/or may be downloaded to the device 102 via the transceiver 106. In either event, a profile including current drains correlated to different functions may be stored in memory 110.

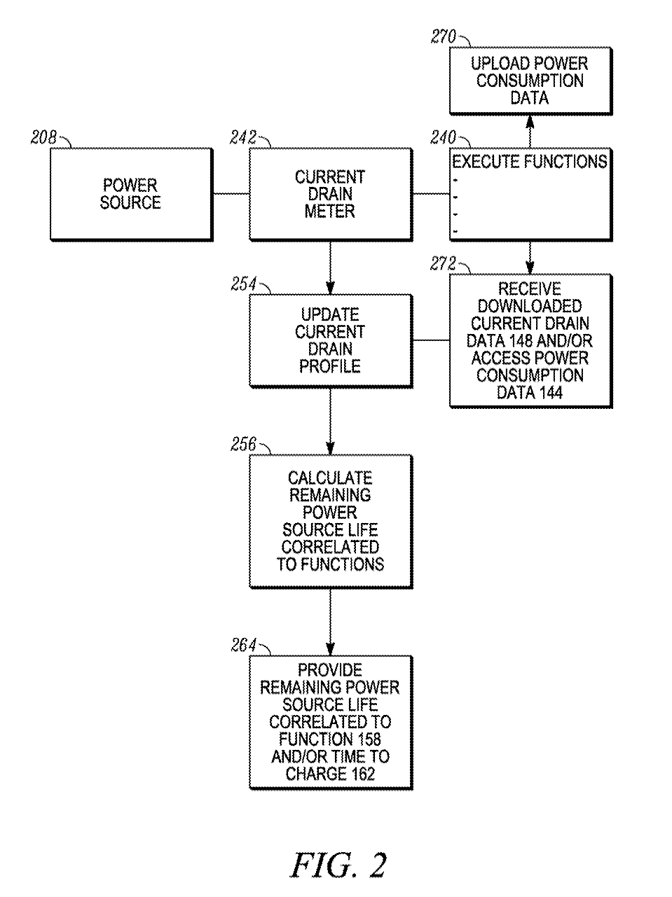

A method for detecting current drain from the power source 108 during execution of a function in accordance with a function module 140 stored in memory 110 of the device 102 can include executing a current drain monitoring module 142 that may be in hardware or software. For internal detection of the current drain from the power source 108, the controller 104 or other processor of the device 102 may be configured as a current drain meter 242 (see FIG. 2) that, for example, may be coupled to a current drain monitoring module 142. Monitoring current drain during the execution of a mode, operation and/or function may provide power consumption data 144. Power consumption data 144 may include the amount of current drawn during the execution of one or more functions, individually and/or simultaneously. Power consumption data 144 may also be correlated to the remaining voltage of the power source 108. Power consumption data 144 may further include additional power source data such as, for example, temperature, a unique power source identification (a serial number, for example), power source characteristics such as manufacture date, capacity, calculated internal resistance, and time since last charge. As will be discussed in more detail, a current drain information profile 146 may be stored in memory 110, updated in accordance with internally monitored current drain by the current drain meter 242 and/or, as mentioned above, by externally provided downloaded current drain profile information 148. The current drain information profile 146 can be related to current drain during operation of at least one of multiple functions and may be updated with either or both internally generated power consumption data 144 and/or downloaded current drain information 148.

A memory 110 of the device 102 may be used to store information 130 such as profiles, data, look-up tables, statistical models, and calculated values. The memory 110 may also be used to store modules 136 that are configured to carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

As mentioned above, modules can include a function module 140 to carry out functions of the device and a current drain monitoring module 142 coupled to the controller 104 that can be configured to detect the current drain of the power source 108 in conjunction with operation of at least one of the multiple functions to generate power consumption data 144. As mentioned data such as power consumption data may be stored in memory 110 as information 130. While in this discussion there is reference to functions of the device 102, it is understood that a function can be for example, any mode, feature, operation, process, mechanism or activity that the device is configured to carry out. A function may be executed in accordance with a function module 140.

The modules can also include a current drain information download module 150 that can be coupled to the controller 104, configured to receive via the transceiver 106 downloaded current drain information 148 related to current drain during operation of at least one of multiple functions. An updating module 152 that can be coupled to the controller 104 can be configured to update current drain profile information 146 stored in memory based on the power consumption data 144 and/or the downloaded current drain information 148 to generate an updated current drain profile 154. A calculation module 156 that can be coupled to the controller 104 can be configured to calculate one or more remaining power source life values 158 for the power source 108 correlated to operation of at least one of the multiple functions, based on the updated current drain profile 154. A time-to-charge module 160 can be coupled to the controller 104 and configured to calculate one or more time-to-charge values 162 based on the remaining power source 108 life value correlated with and during operation of at least one of the multiple functions. An information providing module 164 coupled to the controller 104 can be configured to provide information relating to one or more remaining power source life values 158 and/or time-to-charge values 162 correlated to operation of at least one of the multiple functions.

As mentioned above, a current drain information profile 146 may be stored in memory 110. The current drain information profile may be used in calculating remaining power source life values 158 and time-to-charge values 162. Updating the current drain information profile 146 may occur in different manners as mentioned above. In one embodiment, the information collected during current drain monitoring by the current drain monitoring module 142 may be used to update the current drain information profile 146. In another embodiment, or in addition to the previously mentioned embodiment, the current drain information profile 146 can be updated by downloaded current drain information 148. A generic current drain information profile 146 can be deployed by default before an update takes place, or in lieu of an updated current drain information profile 154.

For updating the current drain information profile 146, the transceiver 106 may receive downloaded current drain information 148. Depicted in FIG. 1 is a remote server 120 that may be within a wireless communication network. The network of course may be any type of wireless network including an ad hoc or wireless personal area network, a WiFi or wireless local area network, and a cellular or wireless wide area network. Likewise, the server 120 may be of any suitable configuration. The server 120 may be implemented as a single server or as a plurality of servers in communication in any arrangement. The operations of the server 120 may be distributed among different servers or devices that may communicate in any manner. It is understood that the depiction in FIG. 1 is for illustrative purposes.

In addition or in the alternative to receiving the current drain information related to current drain of an operation of at least one of multiple functions from the remote server 120 via the transceiver 106, one or more transceivers 106 can be configured to receive the current drain information via a wireless or wired transceiver process. A mobile communication device 102 of course, can include more than one transceiver 106. It is understood that one or more wired or wireless transceivers 106 may be used to download the downloaded current drain information. For example, device 102 may include more than one transceiver 106, for example transceivers for cellular, Bluetooth, WLAN and WiMax that might be used to receive downloaded current drain information 148, and as will be discussed below, upload internally collected power consumption data 144 to a remote server. In addition, or in the alternative to a wireless transceiver 106, a wired transceiver 106 may be used, for example, in conjunction with a USB port 124.

A generic or previously updated current drain information profile 154 stored in memory 110 can include, for example, profile variables or constants extrapolated from a statistical model taking into account one, some or all of the various functions of the device and expected current drain correlated to the functions. A probability of an application occurrence, either initiated by a user, or initiated by the device, may be determined in accordance with one or more statistical models. A statistical model may be for example, a regression model. It is understood that any appropriate statistical model in conjunction with either downloaded current drain information 148 and/or internally collected power consumption data 144 may be used to generate an updated current drain information profile 154.

An updated current drain information profile 154 may take into account different information and situations gathered from different sources such as power consumption data 144 and/or downloaded current drain information 148. The updating module 152 can be configured to dynamically update a current drain profile 146 stored in memory 110 based on the downloaded current drain information 148 and/or internally collected power consumption data 144 to generate an updated current drain profile 154. For example, different information may include one or more historical patterns of use by one or more users of the mobile communication device 102. Historical patterns may include most recent usage, usage over a predefined time period, average usage, and/or overall usage. Different users of the same device 102 may use the device 102 differently. There may be more than one current drain profile 146 updated in accordance with this discussion.

In another example, were a new application installed in the device 102, the current drain profile 146 may be updated with monitored current drained from the power source 108 during execution of the new application. Moreover, the specific power source 108 of the device 102 may have anomalies so that it may drain current at different rates depending upon its stored voltage. Inherent battery variability, model errors and hardware errors, for example may be taken into account in generating an updated current drain information profile 154. It may be found that the current drain for running two applications simultaneously does not equal the sum of running the two applications individually. Any other characteristics of current drain information that are based on variables and/or that are constant are within the scope of this discussion. A dynamically updated current drain profile 154 in real-time and/or near to real-time may help a user be apprised of the power supply consequences of running particular functions of his or her mobile communication device 102.

As mentioned the updated current drain information profile 154 can be based on downloaded current drain profile information 148. A user may opt-into receiving the downloaded current drain information, for example, by choosing a preference or during cellular telephone account initiation. On the other hand, a cellular service may provide the downloaded current drain information 148 along with other standard downloads.

FIG. 2 is a flow chart of an embodiment of steps of a method with reference to certain components described above. Illustrated is the execution of functions 240 that is monitored by a current drain meter 242. During the execution of functions 240, the current drain from power source 208 can be monitored by a current drain meter 242 in accordance with the current drain monitoring module 142 (see FIG. 1).

The current drain meter 242 can be in hardware and/or software and can monitor current drain with respect to functions 240 during their execution. Any suitable manner in which to monitor current drain during the execution of functions 240 is within the scope of this discussion. It is understood, in lieu of monitoring current drain or in combination with the current drain meter 242 the downloaded current drain information 148 (see FIG. 1) may be used to generate the updated current drain information profile 154.

In one embodiment, power consumption data 144 (see FIG. 1) detected by internal monitoring of the device 102 may be uploaded to a remote server 270. The power consumption data 144 or other internally collected data can be transmitted via the transceiver 106 for example, via SMS and/or in manners described above with reference to downloading from a remote server 120. Uploaded data 270 may provide an opportunity for statistical harvesting that can be considered in generating the downloaded current drain information profile 148. Moreover, uploaded data 270 may help improve development of generic default models, particular with regard to new applications or features.

Receiving the downloaded current drain data 148 and/or accessing the power consumption data 144 may be used 272 to update the current drain profile 254. It is understood that any manner for updating a current drain profile 254 is within the scope of this discussion. In accordance with an updated current drain profile 154 (see FIG. 1), a calculation module 156 can be configured to calculate 256 a remaining power source life value 158 correlated to operation of at least one of the multiple functions. Calculating 256 a remaining power source life value 158 may include utilizing a lookup table of energy versus measured voltage. Calculating 256 a remaining power source life value 158 may alternatively or in addition include utilizing an autoregressive statistical model based on historical patterns, downloaded profile or an updated profile. In another example, the power source life value 158 may be calculated as the remaining power source energy divided by an average profile of power consumption, in which the average profile may be based on a generic profile and/or an updated profile 146.

An information providing module 164 (see FIG. 1) coupled to the controller 104 can be configured to provide 264 remaining power source life value 158 and/or one or more time-to-charge values 162 correlated to operation of at least one of the multiple functions of the device 102. As mentioned above, providing information can include displaying indicia, for example the battery icon 118 on the display 112 of the device 102, and/or producing an audible signal generated by a speaker 116, or in any other suitable manner.

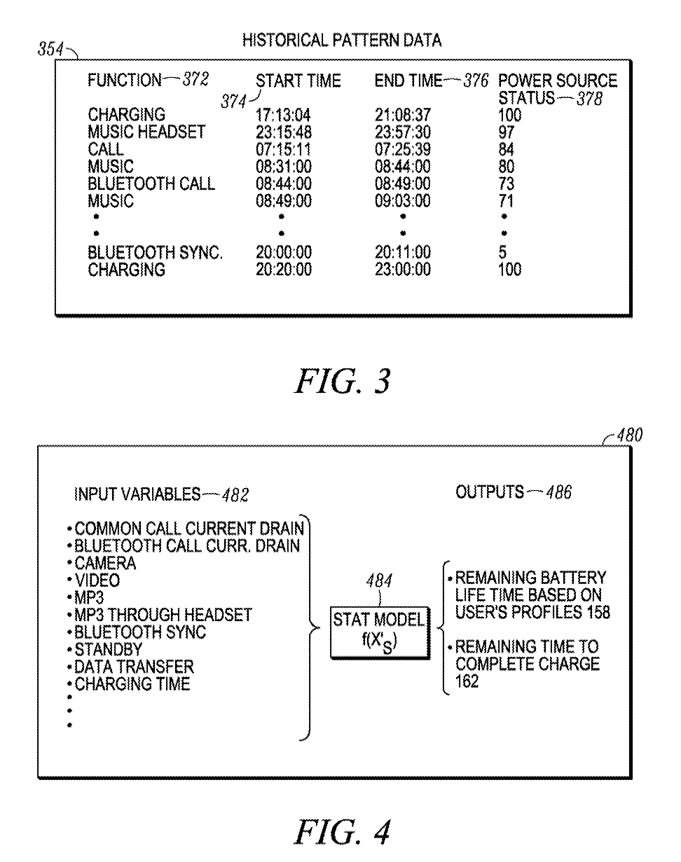

FIG. 3 illustrates an example of historical pattern data 354 that can be stored in memory 110 of the device 102. Historical pattern data 354 can include for example a function 372, a start time 374, an end time 376 and a power source status 378. The power source status can include the energy capacity status of the power source, in this embodiment provided in terms of percentage of a total capacity. It is understood in this discussion that power source capacity status may be provided in any appropriate manner.

When historical pattern data is employed in conjunction with additional usage information, such as a probability of occurrence or usage for each function of the device 102, along with average power consumption for each function, a current drain profile can be constructed and stored in memory 110 of the device. The current drain profile stored in memory may be a generic profile, a downloaded profile or an updated profile as described above. The profile can be provided to a user in any manner, for example it may be displayed on the display 112.

FIG. 4 depicts a statistical model diagram 480. As discussed above, various input variables and/or constants 482 of the profile may be considered. The statistical model 484 may be used in the calculation 256 (see FIG. 2) of the output 486 including but not limited to the remaining power source life time based on the user's profiles 158 and/or the remaining time-to-charge 162.

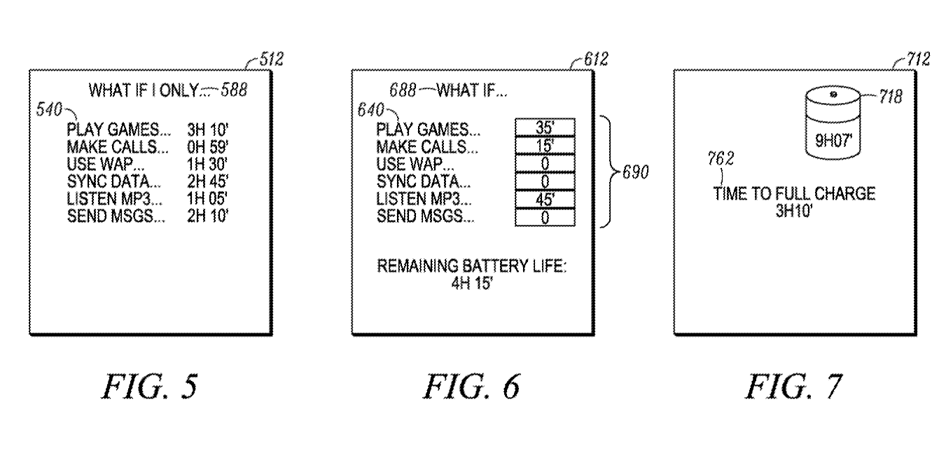

FIG. 5 depicts a display screen 512 providing an embodiment of indicia related to the remaining power source life value 158 (see FIG. 1) correlated to operation of at least one of the multiple functions of the device. The information of the display screen may be provided based on a prompt to the user. It is understood that the remaining power source life value 158 may be presented in any suitable manner. In this example, a “what if” scenario 588 is portrayed so that a plurality of functions 540 are enumerated and the remaining power source life value 158 based on the execution of those functions 540 is displayed.

FIG. 6 depicts a display screen 612 providing an embodiment of indicia related to the remaining power source life value 158 (see FIG. 1) based on hypothetical percentages or other hypothetical criteria that may be entered by the user. A “what if” scenario 688 may be calculated for various functions 640 that may be selected by the user or provided by a default list where a user provides values 690 for example via the input device 114. In one embodiment, a user may fill in blanks provided to give weighted values towards, for example, music, video or web browsing. In one embodiment, a user can save, edit, delete or name profiles. It is understood that any type of “what if” scenarios may be provided in accordance with this discussion.

FIG. 7 depicts a display screen 712 providing indicia relating to a time-to-charge value 762. As mentioned above, the time-to-charge value 162 (see FIG. 1) may be calculated so that it is correlated to a function that is operating during the period of time a charge is taking place. As with the “what if” scenarios described above a time-to-charge value 162 may be calculated on a hypothetical bases as well. The display screen 712 also depicts a battery icon 718 similar to that shown in FIG. 1 that may be correlated to the function during its operation. Indicia related to the time-to-charge value 762 may be correlated to any function, including a stand-by mode.

In accordance with above described methods and device, a visually and/or audibly conveyed power source indicator such as remaining power source life value and time-to-charge value may provide information correlated to operation of at least one of the multiple functions of the device. In this way, a user may be apprised of the power supply consequences of running particular functions of his or her mobile communication device. A user may be better able to plan their time, try new use cases, and increase network utilization when better informed about the remaining power source life value and/or time-to-charge value.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a multi-function mobile communication device including a power source, memory, and a transceiver, the device configured to execute multiple functions, the method comprising:
receiving via the transceiver downloaded current drain information related to current drain during operation of at least one of multiple functions;
updating a current drain profile stored in memory based on the downloaded current drain information to generate an updated current drain profile;
calculating a remaining power source life value for the power source correlated to operation of at least one of the multiple functions, based on the updated current drain profile; and
providing information related to the remaining power source life value correlated to operation of at least one of the multiple functions.

2. The method of claim 1, further comprising:
monitoring the current drain of the power source in conjunction with operation of at least one of the multiple functions to generate power consumption data; and
transmitting via the transceiver power consumption data to a remote server.

3. The method of claim 1, further comprising:
detecting the current drain of the power source in conjunction with operation of at least one of the multiple functions to generate power consumption data; and
updating a current drain profile stored in memory based on the power consumption data to generate an internally generated updated current drain profile.

4. The method of claim 1, wherein the current drain profile is a generic current drain profile.

5. The method of claim 1, further comprising:
calculating a time-to-charge value based on the remaining power source life value correlated with and during operation of at least one of the multiple functions; and
providing information relating to the time-to-charge value correlated with operation of at least one of the multiple functions.

6. A multi-function mobile communication device including a power source, a controller, memory, and a transceiver, the device configured to execute multiple functions, the device comprising:
a current drain information download module coupled to the controller, configured to receive via the transceiver downloaded current drain information related to current drain during operation of at least one of multiple functions;
an updating module coupled to the controller, configured to update a current drain profile stored in memory based on the downloaded current drain information to generate an updated current drain profile;
a calculating module coupled to the controller, configured to calculate a remaining power source life value for the power source correlated to operation of at least one of the multiple functions, based on the updated current drain profile; and
an information providing module coupled to the controller, configured to provide information related to the remaining power source life value correlated to operation of at least one of the multiple functions.

7. The device of claim 6, wherein the updating module comprises a first updating module, the device further comprising:
a detection module coupled to the controller, configured to detect the current drain of the power source in conjunction with operation of at least one of the multiple functions to generate power consumption data; and
a second updating module coupled to the controller, configured to update a current drain profile stored in memory based on the power consumption data to generate an internally generated current drain profile.

8. The device of claim 6, further comprising:
a time-to-charge module coupled to the controller, configured to calculate a time-to-charge value based on the remaining power source life value correlated with and during operation of at least one of the multiple functions; and
a time-to-charge information providing module coupled to the controller, configured to provide information relating to the time-to-charge value correlated with operation of at least one of the multiple functions.

9. The device of claim 6, wherein the functions of the device include at least two from the group of wireless communication, camera functions and multi-media functions.

10. A method of a multi-function mobile communication device including a power source, memory, and a transceiver, the device configured to execute multiple functions, the method comprising:
storing in the memory a current drain information profile related to current drain during operation of at least one of multiple functions;
monitoring the current drain of the power source in conjunction with operation of at least one of the multiple functions to generate power consumption data;
updating a current drain profile stored in memory based on the power consumption data to generate an updated current drain profile;
calculating a remaining power source life value for the power source correlated to operation of at least one of the multiple functions, based on the updated current drain profile; and
providing information relating to the remaining power source life value correlated to operation of at least one of the multiple functions.

11. The method of claim 10, further comprising:
receiving via the transceiver downloaded current drain information related to operation of at least one of multiple functions;
updating the current drain profile stored in memory based on the downloaded current drain information.

12. The method of claim 10, further comprising:
monitoring the current drain of the power source in conjunction with operation of at least one of the multiple functions to generate power consumption data; and
transmitting via the transceiver power consumption data to a remote server.

13. The method of claim 10, further comprising:
calculating a time-to-charge value based on the remaining power source life value correlated with and during operation of at least one of the multiple functions; and
providing information relating to the time-to-charge value correlated with operation of at least one of the multiple functions.

14. A multi-function mobile communication device including a power source, memory, a controller and a transceiver, the device configured to execute multiple functions, the device comprising:
a current drain information profile related to current drain during operation of at least one of multiple functions stored in memory;
a current drain monitoring module coupled to the controller, configured to monitor the current drain of the power source in conjunction with operation of at least one of the multiple functions to generate power consumption data;
an updating module coupled to the controller, configured to update a current drain profile stored in memory based on the power consumption data to generate an updated current drain profile;
a calculation module coupled to the controller, configured to calculate a remaining power source life value for the power source correlated to operation of at least one of the multiple functions, based on the updated current drain profile; and
an information providing module coupled to the controller, configured to provide information related to the remaining power source life value correlated to operation of at least one of the multiple functions.

15. The device of claim 14, wherein the updating module comprises a first updating module, the device further comprising:
a current drain information download module coupled to the controller, configured to receive via the transceiver downloaded current drain information related to operation of at least one of multiple functions; and
a second updating module coupled to the controller, configured to update a current drain profile stored in memory based on the downloaded current drain information to generate an updated current drain profile.

16. The device of claim 14, wherein the current drain profile is a generic current drain profile.

17. The device of claim 14, further comprising:
a time-to-charge module coupled to the controller, configured to calculate a time-to-charge value based on the remaining power source life value correlated with and during operation of at least one of the multiple functions; and
a time-to-charge information providing module coupled to the controller, configured to provide information related to the time-to-charge value correlated with at least one of the multiple functions.

18. The device of claim 14, wherein the functions of the device include at least two from the group of wireless communication, camera functions and multi-media functions.
